(19) United States
(12) Patent Application Publication
(10) Pub. No.: US 2014/0139430 A1
(43) Pub. Date: May 22, 2014

(54) VIRTUAL TOUCH METHOD

(71) Applicant: QUANTA COMPUTER INC., Kuei Shan Hsiang (TW)

(72) Inventor: Chee-Chun Leung, Kuei Shan Hsiang (TW)

(73) Assignee: Quanta Computer Inc., Kuei Shan Hsiang, (TW)

(21) Appl. No.: 13/804,068

(22) Filed: Mar. 14, 2013

(30) Foreign Application Priority Data
Nov. 16, 2012 (TW) 101142752

(51) Int. Cl. G06F 3/01

(52) U.S. Cl. CPC G06F 3/011
USPC 345/157; 345/156

(57) ABSTRACT

The invention provides a virtual touch method applied to a computer provided with a camera, including: defining a virtual touch plane in the space in front of the screen of the computer, capturing a reference fingertip image of a finger touching the virtual touch plane by the camera and storing the reference fingertip image, capturing an operation fingertip image of the finger in a touch operation by the camera, and comparing the sizes of the reference fingertip image and the operation fingertip image to determine whether the finger touches or pierces through the virtual touch plane.

### CROSS REFERENCE TO RELATED APPLICATIONS

This Application claims priority of Taiwan Patent Application No. 101142752, filed on Nov. 16, 2012, the entirety of which is incorporated by reference herein.

### BACKGROUND OF THE INVENTION

1. Field of the Invention

The present invention relates to a virtual touch method, and in particular to a virtual touch method for forming a virtual touch plane in front of a computer screen.

2. Description of the Related Art

A new operation system released by Microsoft fully applies touch functions therein to make a more convenient operation interface for users. However, applying the conventional touch panel to a desktop computer or a notebook computer is not difficult, but the cost is high. For now, only a few models are embedded with a touch panel to support touch operations. Apparently, this kind of computer is not popular.

To solve the above issue, the invention provides a virtual touch method applicable to most of the present desktop or notebook computers, which utilizes a camera configured on the computer screen to provide a virtual touch plane in front of the screen, which lets users enjoy touch-screen functionality on conventional computer products.

### BRIEF SUMMARY OF THE INVENTION

A detailed description is given in the following embodiments with reference to the accompanying drawings.

The invention provides a virtual touch method applied to a computer provided with a camera, including: defining a virtual touch plane in the space in front of the screen of the computer; capturing a reference fingertip image of a finger touching the virtual touch plane by the camera and storing the reference fingertip image; capturing an operation fingertip image of the finger in a touch operation by the camera; and comparing the sizes of the reference fingertip image and the operation fingertip image to determine whether the finger touches or pierces through the virtual touch plane.

According to an embodiment of the invention, the default position of the virtual touch plane is right above a row of keys in the keyboard of the computer.

According to an embodiment of the invention, the screen of the computer displays a cursor, wherein the color of the cursor changes as the distance between the finger and the virtual touch plane changes.

According to an embodiment of the invention, the virtual touch method further includes: defining the space which is sandwiched between the virtual touch plane and a parallel plane located at the side opposite to the screen of the computer as a hover space; and defining the space which is sandwiched between the virtual touch plane and a parallel plane located at the screen side as a touch space, wherein the screen displays a cursor. The movement of the finger in the hover space controls the movement of the cursor, and the movement of the finger in the touch space directs the cursor to drag an object.

According to an embodiment of the invention, a gesture where the finger touches or pierces through the virtual touch plane from the hover space and then moves back to the hover space instantly is determined as a click.

According to an embodiment of the invention, the cursor is represented in different colors when the finger is located in the hover space, the touch space, and the space other than the hover space and the touch space. In the case where the finger is located in the hover space or the touch space, the color depth of the cursor varies according to the distance between the finger and the virtual touch plane.

According to an embodiment of the invention, the virtual touch method further includes: defining a touch area of the virtual touch plane such that the touch area corresponds to the display area of the screen of the computer. In the field of view of the camera, the edges of the touch area is able to be adjusted.

According to an embodiment of the invention, the virtual touch method is performed by a program, and the program is executed by clicking the icon of the program with a mouse, pressing a hotkey in the keyboard, or issuing a voice command

According to the above embodiments, the invention provides a virtual touch plane in the space in front of a computer screen and captures fingertip images by a camera. Therefore, the user can enjoy touch-screen functionality on conventional computers without changing equipment.

### BRIEF DESCRIPTION OF THE DRAWINGS

The present invention can be more fully understood by reading the subsequent detailed description and examples with references made to the accompanying drawings, wherein:

FIG. 1 is an oblique view of a conventional notebook computer provided with a camera on the screen.

FIG. 2 is an oblique view showing a virtual touch plane formed for the conventional notebook computer shown in FIG. 1.

FIG. 3 is a side view showing a virtual touch plane formed for the conventional notebook computer shown in FIG. 1.

FIG. 4 is a flowchart of a virtual touch method in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

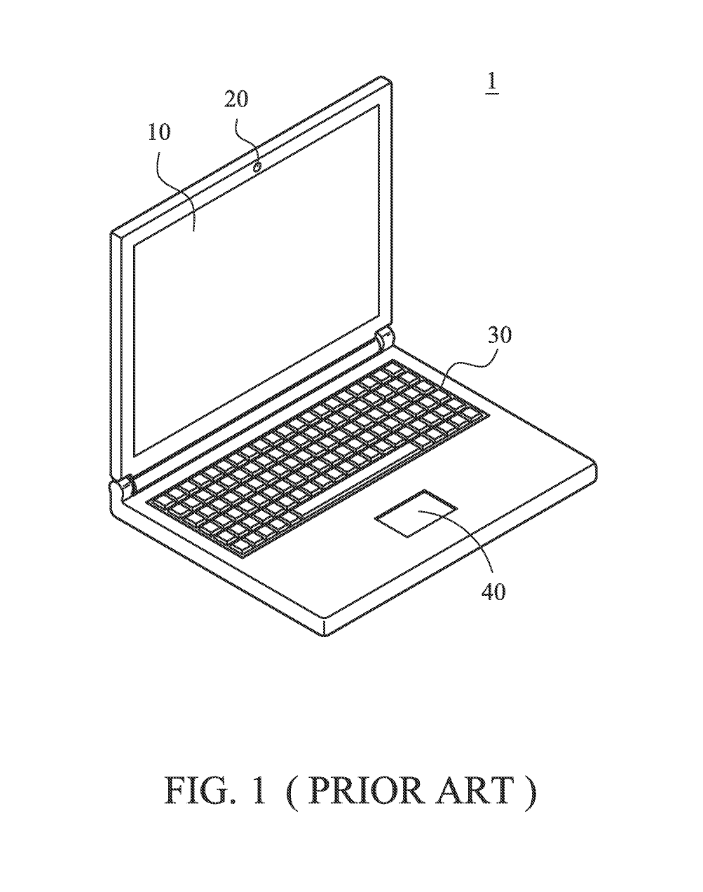

FIG. 1 is an oblique view of a conventional notebook computer provided with a camera on the screen. As shown in FIG. 1, the conventional notebook computer 1 basically has an upper module including a screen 10 and a camera 20, and a lower module including a keyboard 30 and a mouse panel 40. The virtual touch method of the invention is applied to the notebook conventional computer 1 provided with the camera 20 as shown in FIG. 1.

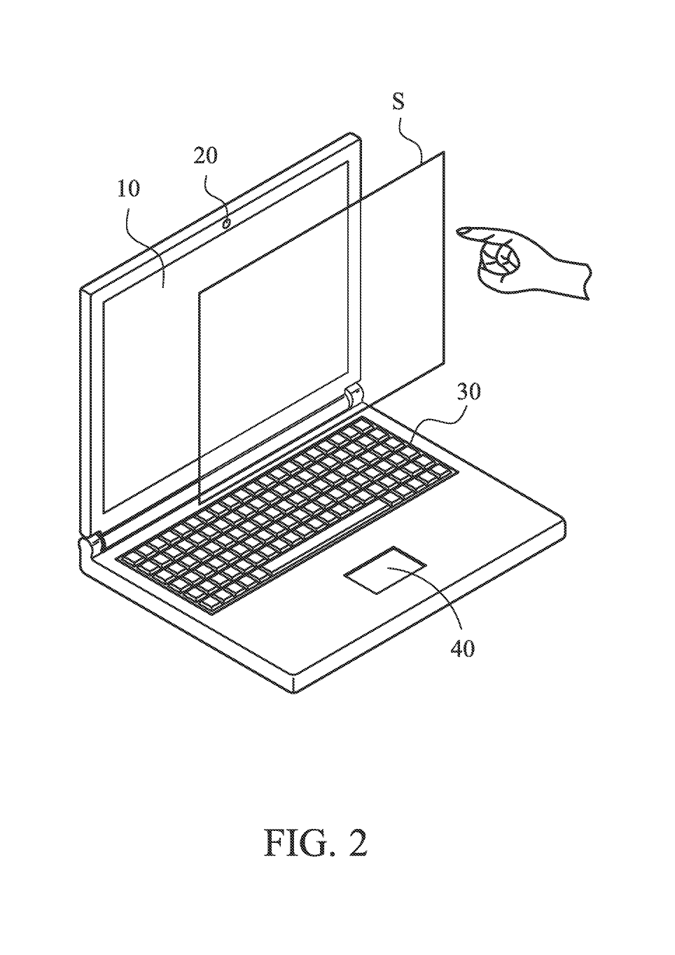

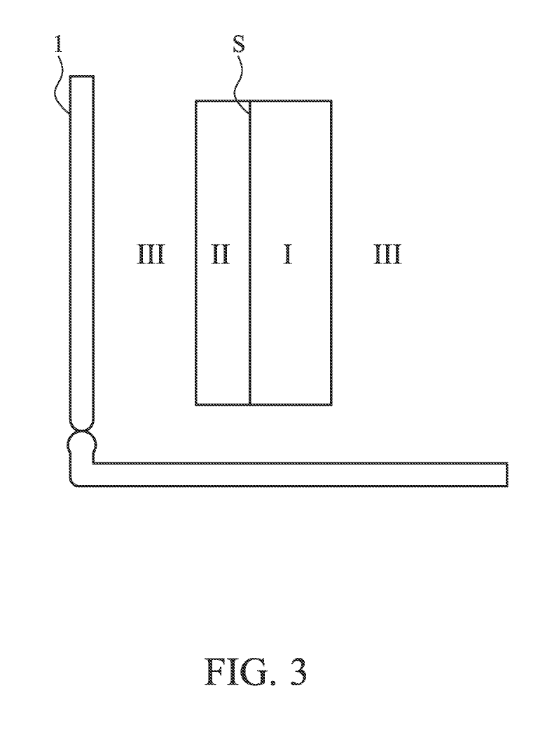

FIG. 2 is an oblique view showing a virtual touch plane formed for the conventional notebook computer shown in FIG. 1. FIG. 3 is a side view showing a virtual touch plane formed for the conventional notebook computer shown in FIG. 1.

Generally, when a user is using a computer, his lower arms are usually leaning on the desk and his fingers are placed on the keys of the keyboard. Therefore, as shown in FIG. 2, in the invention, a virtual touch plane S is formed in a space above the keyboard 30. The virtual touch panel S is perpendicular to the desk plane. The user can touch the virtual touch panel S to control a cursor shown by the screen 10 to perform touch operations.

The conventional notebook computer 1 is provided with a camera 20 on the screen 10 for providing video communication. The invention utilizes the camera 20 to capture a fingertip image of a finger and then calculates the position of the finger according to the image position and the distance between the finger and the screen 20 according to the size of the image. More specifically, the virtual touch method of the invention forms a virtual touch plane S in the space in front of the screen 10, stores the fingertip image of the finger located at the center of the virtual touch plane S as a reference image, and then compares the sizes of the fingertip image captured in the touch operation and the reference image. If the size of the fingertip image is equal to or larger than the size of the reference image, it is determined that the finger touches or pierces through the virtual touch plane S. In this way, touch functions can be easily performed without adding any components or changing the design of the computer.

The setting method for the virtual touch plane S is described in the following. According to an embodiment of the invention, the default position of the virtual touch plane S is above a predetermined position on the keyboard 30. For example, when a user utilizes the keyboard 30, the fingers of his left hand are usually placed at the “F”, “D”, “5”, and “A” keys, and the fingers of his right hand are usually placed at the “J”, “K”, “L”, and “;” keys. This operation position is called the initial position. When the computer 1 activates the virtual touch method, the default position of the virtual touch plane S can be right above the initial position. However, the position of the virtual touch plane S can be adjusted forward or backward according to the user's preference. For example, the screen 10 displays information which directs the user to put his finger at a position which is at the center point of a new virtual touch plane S. Therefore, the position of the new virtual touch plane S is determined.

Next, the setting method for a touch area is described. The touch area means a sensible area in the virtual touch plane S. The touch area is a rectangle corresponding to the display area of the screen 10. In this way, the finger moving in the touch area corresponds to a cursor moving in the display area of the screen 10. If the finger moves outside of the touch area, the gesture is not determined as a touch operation. According to an embodiment of the invention, the size of the default touch area is approximate to the size of the display area of the screen 10. Therefore, the movement of the finger and the movement of the cursor is close to 1:1. However, the touch area can be adjusted according to the user's preference. For example, the screen 10 displays information which directs the user to put his finger at a position which is at the boundary of a new touch area. Therefore, the new touch area is determined

Next, an operation space and a non-operation space of the virtual touch method are explained by referring to FIG. 3. As shown in FIG. 3, the space sandwiched between the virtual touch plane S and a parallel plane located at the user's side is defined as a hover space I. The default thickness of the hover space I (the distance between the virtual touch plane S and the parallel plane located at the user's side) is, for example, 10 cm. The space sandwiched between the virtual touch plane S and a parallel plane located at the side of the screen 10 is defined as a touch space II. The default thickness of the touch space II (the distance between the virtual touch plane S and the parallel plane located at the side of the screen 10) is, for example, 5 cm. The space outside the hover space I and the touch space II is defined as non-operation space III. The thicknesses of the hover space I and the touch space II can remain at a default value or be adjusted by the user.

When a finger enters the hover space I, the camera 20 starts to capture the position of the finger and the cursor displayed on the screen 10 moves to a corresponding position accordingly. Therefore, the movement of the cursor can be controlled by the movement of the finger in the hover space I. When the finger further pierces through the virtual touch plane S to enter the touch space II and moves in the touch space, an object overlapped by the cursor is grabbed and dragged along the moving track of the finger. When the finger touches or pierces through the virtual touch plane S and then moves back to the hover space I instantly, the gesture is determined as a cursor click. When the finger is placed in the non-operation space III, no touch operation is performed.

However, in real touch operations, the user cannot easily know the exact position of the virtual touch plane. To solve this problem, in the invention the color of the cursor changes as the distance between the finger and the virtual touch plane changes. This interaction reaction let the user easily know the exact position of the virtual touch plane S.

According to an embodiment of the invention, because the user eyes the cursor displayed by the screen 10 in the touch operation, the characteristic of the cursor can change such that the user can notice the position of the finger with respect to the virtual touch plane S. For example, when the finger enters the hover space I, the cursor is represented in light red, and the color of the cursor becomes darker as the finger approaches the virtual touch plane S. When the finger just touches the virtual touch plane S, the cursor is represented in yellow. When the finger enters the touch space II, the cursor is represented in green, and the color of the cursor becomes lighter as the finger leaves the virtual touch plane S. Otherwise, when the finger is placed at the non-operation space III, the cursor is represented in gray, showing that the cursor is not yet controlled by the finger. In this way, the user can easily know in which space the finger is located and the probability of making an operation mistake can be reduced.

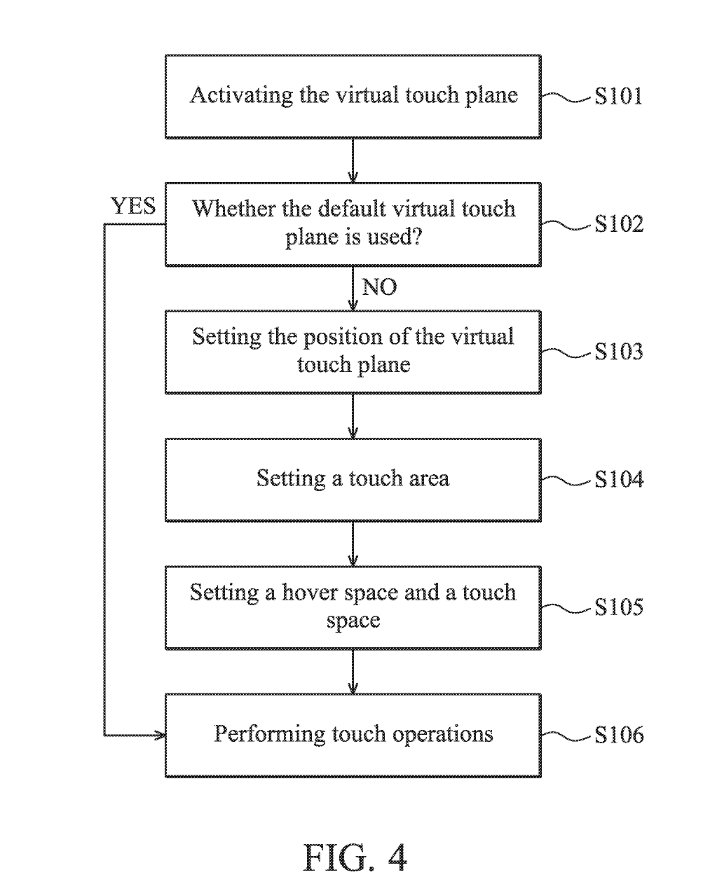

Next, the steps of the virtual touch method of the invention are described. FIG. 4 is a flowchart of a virtual touch method in accordance with an embodiment of the invention.

First, in step S101, the virtual touch panel is activated. The virtual touch method of the invention is performed by a program stored in a storage media of the computer. The program can be executed by clicking the icon of the program, pressing a hotkey on the keyboard, or issuing a voice command In step S102, the screen displays a window for inquiring whether the user wants to use the default virtual touch plane or not. If the user selects “YES”, the procedure proceeds to step S106 and the touch operation is started. If the user selects “NO”, the procedure proceeds to step S103.

In step S103, the user is asked to set the position of the virtual touch plane. At this time, the screen displays a point at a predetermined position (for example, at the center point of the screen) and the user is asked to place a fingertip at a corresponding position on a virtual touch plane to be set. The camera then captures an image of the fingertip as a reference fingertip image. The position of the reference fingertip image on the pixel array of the image sensor of the camera corresponds to the predetermined position of the point displayed on the screen. The size of the reference fingertip image is determined by the number of the pixels of the image sensor possessed by the reference fingertip image. When the finger gets closer to the camera, the fingertip image becomes larger, and the number of the pixels possessed by the image increases. The size of the reference fingertip image is used to determine the distance between the finger and the virtual touch plane. In the touch operation, if the fingertip image is equal to or larger than the reference fingertip image, it is determined that the finger touches or pierces through the virtual touch plane; otherwise, if the fingertip image is smaller than the reference fingertip image, it is determined that the finger does not approach the virtual touch plane. After the setting, the procedure proceeds to step S104.

In step S104, the user is asked to set the touch area. At this time, the screen displays a point at a predetermined position (for example, at the corner or the edge of the screen) and the user is asked to place a fingertip at a corresponding position to be set on the virtual touch plane. The camera captures an image of the fingertip again. According to this fingertip image and the reference fingertip image captured in step S103, the virtual touch program determines the touch area and the relation between the positions of points on the virtual touch plane and the position of points on the screen. After the position of the virtual touch plane is determined, the size of the touch area is related to the size of an active pixel array which is at least a portion of the entire pixel array in the image sensor. Therefore, as long as the active pixel array is not larger than the entire pixel array in the image sensor (in other words, the touch area is not larger than the field of view of the camera), the touch area can be set freely. However, a small active pixel array can help for decreasing the processing load to raise the processing speed. After the setting, the procedure proceeds to step S105.

In step S105, the user is asked to set the hover space and the touch space. The user can follow the instruction shown on the screen to place his fingertip on the boundary plane of a hover space to be set and the boundary plane of a touch space to be set respectively to determine the thicknesses of the hover space and the touch space, or the user can directly enter the thickness values of the hover space and the touch space via the keyboard. After the setting, the procedure proceeds to step S106.

In step S106, the user is allowed to start touch operations. The gestures used with a conventional touch panel, such as move, click, drag, pinch in, and pinch out, can also be applied to the virtual touch plane. If the user wants to leave the virtual touch program, the user can click a predetermined icon, press a hotkey in the keyboard, or issue a voice command to close the program.

In addition, during the touch operation (step S106) the setting steps S103˜S105 can be called out anytime to modify the settings. Note that if the user is not a user with setting data stored in the database of the virtual touch program, it is preferred that the setting steps S103˜S105 be performed for calibration. In this way, setting data for the new user is established in the database such that the inaccuracy of detection due to the difference of finger characteristics can be avoided.

According to the embodiments, the invention provides a virtual touch plane in the space in front of a computer screen and captures fingertip images by a camera. Therefore, the user can enjoy touch-screen functionality on conventional computers without changing equipment.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A virtual touch method applied to a computer provided with a camera, comprising:
defining a virtual touch plane in the space in front of the screen of a computer;
capturing a reference fingertip image of a finger touching the virtual touch plane by the camera and storing the reference fingertip image;
capturing an operation fingertip image of the finger in a touch operation by the camera; and
comparing the sizes of the reference fingertip image and the operation fingertip image to determine whether the finger touches or pierces through the virtual touch plane.

2. The virtual touch method as claimed in claim 1, wherein the default position of the virtual touch plane is right above a row of keys in a keyboard of the computer.

3. The virtual touch method as claimed in claim 1, wherein the screen of the computer displays a cursor, wherein the color of the cursor changes as the distance between the finger and the virtual touch plane changes.

4. The virtual touch method as claimed in claim 1, further comprising:
defining the space which is sandwiched between the virtual touch plane and a parallel plane located at the side opposite to the screen of the computer as a hover space; and
defining the space which is sandwiched between the virtual touch plane and a parallel plane located at the screen side as a touch space;
wherein the screen displays a cursor, wherein the movement of the finger in the hover space controls the movement of the cursor, and the movement of the finger in the touch space directs the cursor to drag an object.

5. The virtual touch method as claimed in claim 4, wherein a gesture where the finger touches or pierces through the virtual touch plane from the hover space and then moves back to the hover space instantly is determined as a click.

6. The virtual touch method as claimed in claim 4, wherein the cursor is represented in different colors when the finger is located in the hover space, the touch space, and a space other than the hover space and the touch space,
wherein, in cases where the finger is located in the hover space or the touch space, the color depth of the cursor varies according to the distance between the finger and the virtual touch plane.

7. The virtual touch method as claimed in claim 1, further comprising:
defining a touch area of the virtual touch plane such that the touch area corresponds to the display area of the screen of the computer,
wherein, in the field of view of the camera, the edges of the touch area is able to be adjusted.

8. The virtual touch method as claimed in claim 1, wherein the virtual touch method is performed by a program, and the program is executed by clicking the icon of the program with a mouse, pressing a hotkey on the keyboard, or issuing a voice command.
